(19) United States
(12) Patent Application Publication
(10) Pub. No.: US 2025/0291392 A1
(43) Pub. Date: Sep. 18, 2025

(54) Mounting System for a Mobile Computer

(71) Applicant: ZEBRA TECHNOLOGIES CORPORATION, Lincolnshire, IL (US)

(72) Inventors: Chi-Ming Wang, Taipei (TW); Wei-Ti Kuo, Songshan Dist. (TW); Ricardo F. Perez, New Haven, CT (US); Sunghun Lim, Bethpage, NY (US); Li-Ko Wang, New Taipei City (TW)

(21) Appl. No.: 18/604,401

(22) Filed: Mar. 13, 2024

(51) Int. Cl. G06F 1/16; A45F 5/00; A45F 5/02; F16M 13/00; F16M 13/04

(52) U.S. Cl. CPC G06F 1/1679; A45F 5/021; F16M 13/005; F16M 13/04; A45F 2005/008; A45F 5/1525

(57) ABSTRACT

A mounting system for a mobile computer is described herein. The mounting system includes a mount base, a housing, and a latching mechanism. The housing is configured to be secured to the mount base forming a compartment between the housing and the mount base. The latching mechanism is configured to be located within the compartment of the housing. The latching mechanism including a button and at least one latch element and the latch mechanism is biased to a first position. Further, the housing has at least one opening where the at least one latch element is configured to secure to the mobile computer.

### BACKGROUND

Mobile computing devices can be employed in a wide variety of environments. In some environments, a worker may need to have their hands free and therefore they cannot easily carry the mobile computing device in their hands and work simultaneously. As such, it is desirable to facilitate mounting the mobile device to the user. Solutions are discussed further below.

### SUMMARY

In an embodiment, the present disclosure is a mounting system for a mobile computer, the mounting system comprising a mount base, a housing secured to the mount base forming a compartment between the housing and the mount base, and a latching mechanism located within the compartment, the latching mechanism comprising a button and at least one latch element, the latching mechanism biased to a first position. The housing includes at least one opening in which the at least one latch element is configured to secure to the mobile computer.

In another embodiment, when the latching mechanism is in the first position, the latching mechanism is configured to secure the mobile computer to the mount. Further, actuation of the button is operable to move the latching mechanism from the first position to a second position.

In another embodiment, the at least one latching element is configured to engage with a corresponding recess on the mobile computer.

Additionally, the mobile computer further includes an additional button configured to actuate the button when pressed.

In another embodiment, the mount is secured to an arm of a user.

Additionally, the mount is configured to be secured to a belt.

In a further embodiment, the mount is pivotable from a secured position to a viewing position wherein the mobile computer is in a vertical position when in the secured position and in a horizontal position in the viewing position.

Additionally, or alternatively, the mount further includes a main body supporting the mounting mechanism, and a clip element wherein the clip element is rotatably secured to the main body via a first hinge. The clip element is configured to secure to a belt. The clip element includes a first arm and a second arm wherein the first arm is secured to the second arm via a second hinge. Further, the clip element includes a first magnetic element, the first magnetic element configured to magnetically secure to a second magnetic element located on the main body, the second magnetic element opposite the main body from the mounting mechanism.

In a further embodiment, the mobile computing can secure to the main body via the mounting mechanism and the mobile computer can be pivoted up by forcing apart the first and second magnet, and when the mobile computer is pivoted down, the first and second magnet reattach.

In another embodiment, the button is depressed and the mobile computer removed from the mounting system with one hand.

In an embodiment, the present disclosure is a mobile computer mounting system including a mobile computer having a cleat located on a surface of the mobile computer; a mount including: a mount base; a housing secured to the mount base forming a compartment between the housing and the mount base; and a latching mechanism located within the compartment, the latching mechanism configured to secure mesh to the cleat to lock secure the mobile computer to the mount.

Further embodiments includes the latching mechanism includes at least one latch element, and the cleat includes at least one recess, wherein the at least one latch element is configured to mesh with the at least one recess through at least one opening in the housing.

Additional embodiment includes wherein the latching mechanism includes a button configured to translate the latching mechanism within the compartment.

Further embodiments allow an additional button is located on the mobile computer, the additional button is configured to engage the button and translate the latching mechanism.

Additionally, or alternatively, the mount is configured to be secured to an arm of a user. Further, the mount is configured to be secured to a belt of a user.

Additionally, the mount is configured to be pivotably secured such that in a first position, the mobile computer is supported in a substantially vertical position and in a second position, the mobile computer is supported in a substantially horizontal position.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a wrist mounting system for a mobile computing device according to example embodiments of the present disclosure;

FIG. 2 illustrates the mount of FIG. 1 according to example embodiments of the present disclosure;

FIG. 3 illustrates the mount of FIG. 2 with the housing removed for clarity according to an example embodiment of the present disclosure;

FIG. 4 illustrates a side view of mobile computer embodiments secured to the mount of FIG. 2 according to example embodiments of the present disclosure;

FIG. 5 illustrates an exploded view of the wrist mount of FIG. 2 according to example embodiments of the present disclosure;

FIG. 6 illustrates a view of a linkage located in the handle adapter according to example embodiments of the present disclosure;

FIG. 7 illustrates a belt mount according to example embodiments of the present disclosure;

FIG. 8 illustrates another view of the belt mount of FIG. 7 according to example embodiments of the present disclosure;

FIG. 9 illustrates installation and removal of the mobile computer on to the mount according to example embodiments of the present disclosure;

FIG. 10 illustrates the mount of FIG. 7 secured to a mobile computer in the first position according to example embodiments of the present disclosure;

FIG. 11 illustrates the mount of FIG. 7 with the mobile computer pivoted to a second position according to example embodiments of the present disclosure;

FIG. 12 illustrates a cross-section of the mobile device and mount as shown in FIG. 9 according to example embodiments of the present disclosure;

FIG. 13 illustrates a first side view of the mount according to example embodiments of the present disclosure;

FIG. 14 illustrates a second side view of the mount according to example embodiments of the present disclosure;

FIG. 15 illustrates a third side view of the mount according to example embodiments of the present disclosure;

FIG. 16 illustrates a fourth side view of the mount according to example embodiments of the present disclosure;

FIG. 17 illustrates a fifth side view of the mount according to example embodiments of the present disclosure; and

FIG. 18 illustrates a sixth side view of the mount according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The disclosed embodiments will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Wearable mobile computers may have issues when being worn by a user, especially when being worn and secured on an arm. When being used in a commercial environment, the mobile computer may need to be worn by different users throughout a day or shift, and therefore may be transferred between users. In removing a wearable computer from a mounting system, it is advantageous to have it configured for removal by one hand, which would allow it to be worn on an arm or somewhere, not accessible by both hands. Therefore, an ergonomic solution involving release buttons and latches within a mounting mechanism that allows one-handed, securing and removal would be advantageous to users.

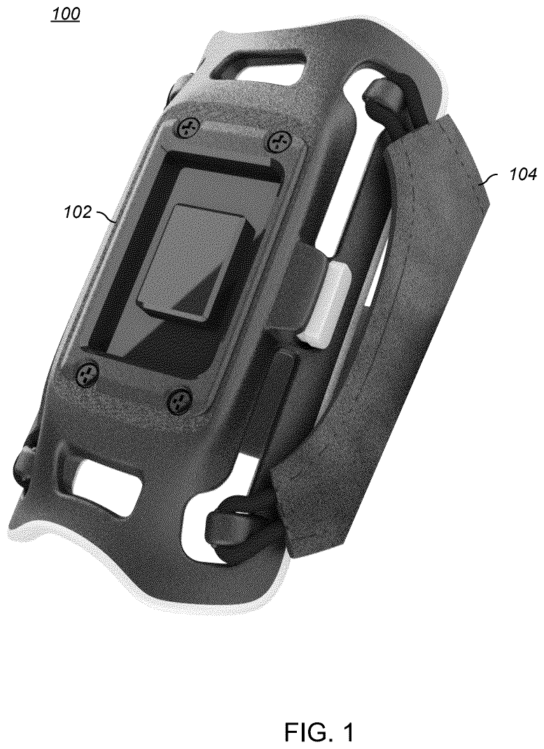

FIG. 1 depicts a wrist mounting system 100. The wrist mounting system 100 includes a wrist mount 102 and a securing apparatus 104. As will be described in further detail below, the wrist mount 102 as depicted is configured to rest on a user's forearm with the securing apparatus 104 further wrapping around the arm and securing the wrist mount 102 to the user. The wrist mount 102 is further configured to receive a mobile computer such that a display of the mobile computer is directed towards the user when the user raises their forearm.

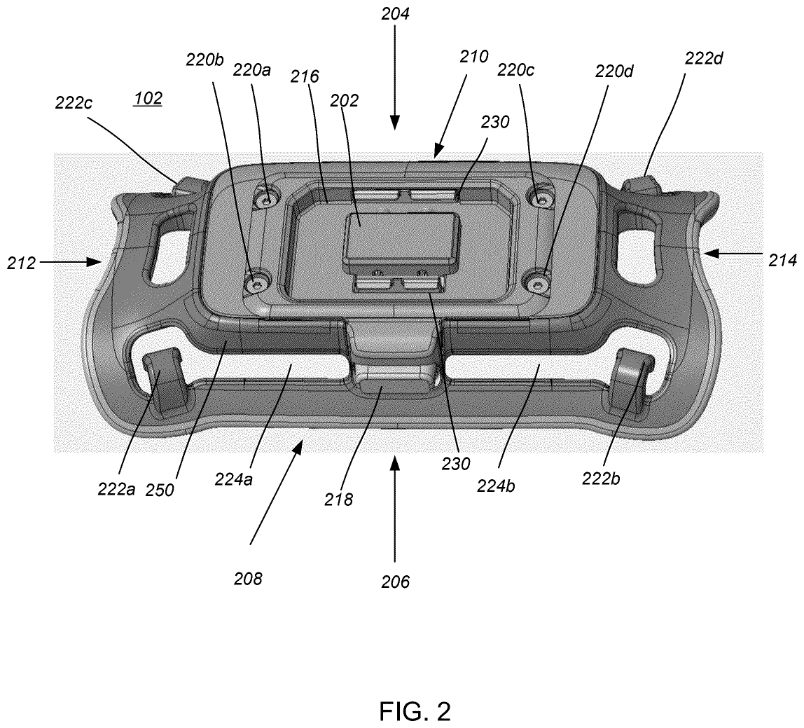

FIG. 2 depicts an isolated view of the wrist mount 102 of FIG. 1. The wrist mount 102, also referred to herein as mount 102, comprises, a mount base 250, a mounting mechanism 202, a release button 218, housing 216, and an ergonomic underside (described further below). The mount 102 is configured to receive a mobile computing device, also referred herein as mobile computer or computer. The mobile computer is configured to rigidly secure to the mounting mechanism 202, where, after securement, the mobile computer does not move relative to the mount 102.

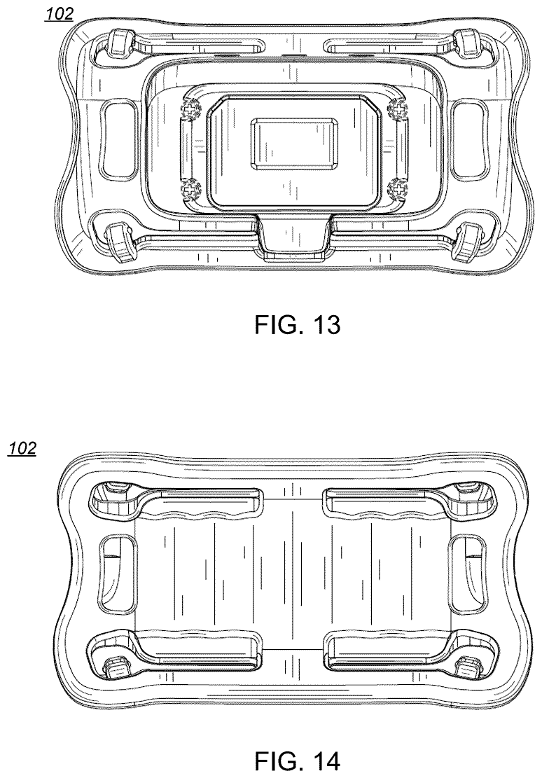

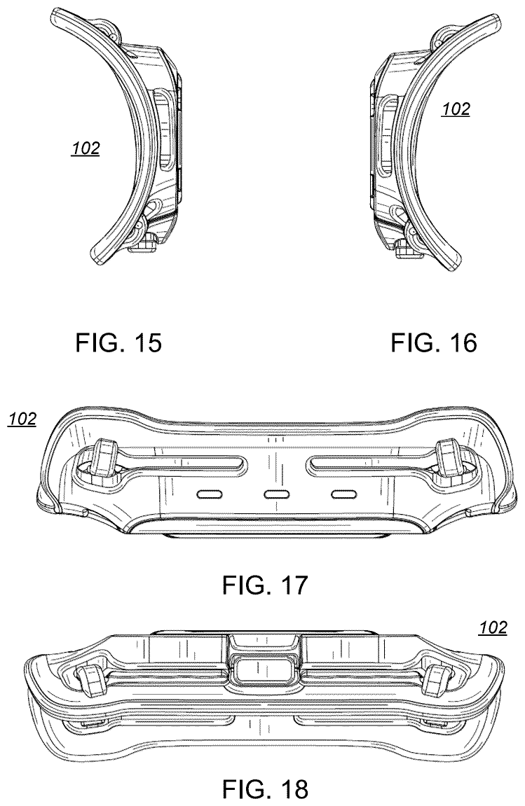

As depicted in FIG. 2, the mount 102 includes a first side 204 (also referred to as the top side), and a second side 206 (also referred to as the bottom side) opposite the first side 204. The mounting mechanism 202 is substantially located on the first side 204. The mount 102 further includes a third side 208 and a fourth side 210 (also referred to herein as the left side and right side, respectively, per the orientation shown in FIG. 2), where the third side 208 is opposite the fourth side 210. The mount 102 further includes a fifth side 212 and a sixth side 214 opposite the fifth side 212. The first, second, third, fourth, fifth, and sixth sides of the mount are shown in FIGS. 13-18 respectively.

In the depicted embodiment of FIG. 2, the mount 102 is configured to rest on a user's arm such that the second side 206 is a cushioned surface that contacts the user's arm. In some embodiments the fifth side 212 is closer than the sixth side 214 to the user's hand when the mount 102 is on the user's arm, and in some embodiments the sixth side 214 is closer to the user's hand.

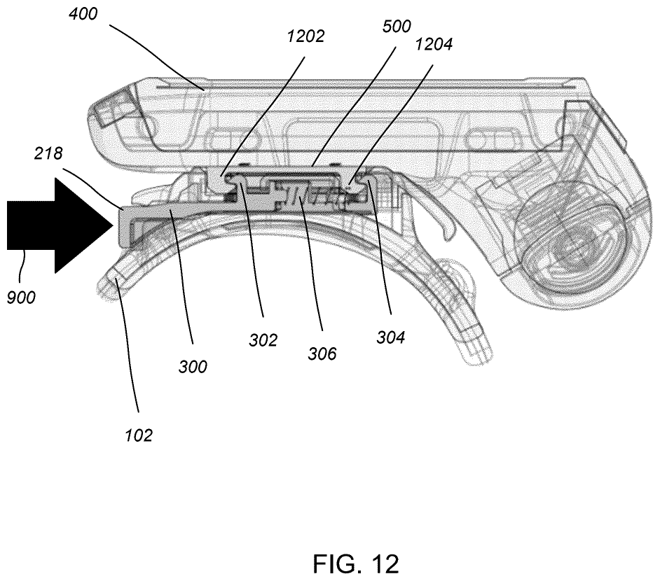

FIG. 2 depicts a housing 216 secured to the first side 204 of the mount 102. The housing 216 is secured to the mount 102 via fasteners 220 (depicted in FIG. 2 as fasteners 220a/220b/220c/220d, collectively fasteners 220). In the depicted embodiment the fasteners 220 are screws, but the fasteners 220 can be any means to secure the housing surface 216 to the mount 102. As will be discussed further below, the housing 216 covers a compartment (not seen) in the mount 102, where a latching mechanism is located within the void. The latching mechanism includes a button 218 which can be accessed from outside the void on the third side 208 of the mount 102 as seen in FIG. 2. The operation of the button 218 and the latching mechanism will be described further below. The housing 216 further includes openings 230. The openings 230 are configured to align with the latching mechanism such that features of the latching mechanism can extend through the housing 216 to mate with features of the mobile computer, which is further depicted in FIG. 12.

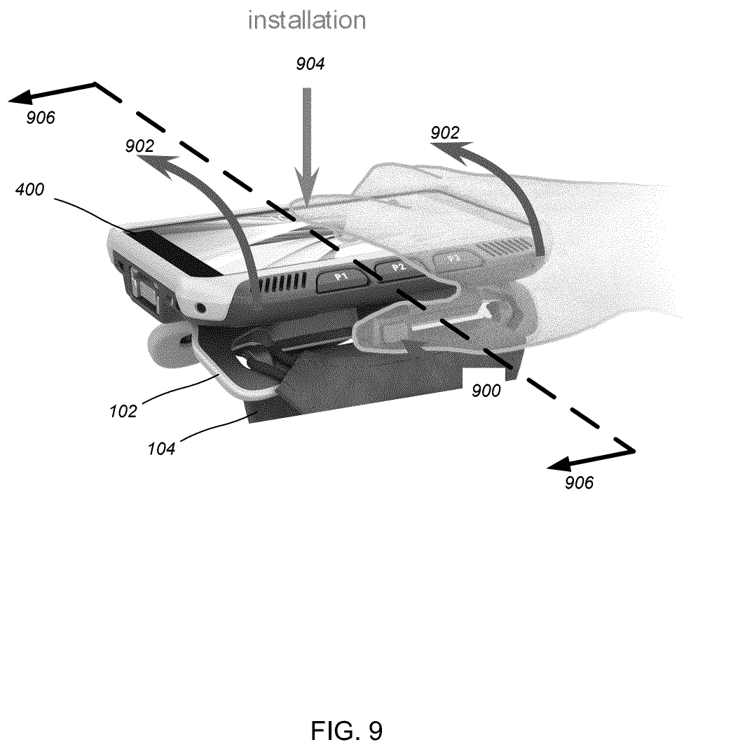

FIG. 12 depicts a cross-sectional view of the embodiment of FIG. 9, sectioned along dotted line 906. When securing a mobile computer 400 to the mount 102, a cleat 500 located on the backside of the mobile computer 400 is configured to mesh with the mounting mechanism 202. The mounting mechanism 202 includes a latching mechanism 300 within the compartment (described further below,) where the latching mechanism is biased (due to a biasing mechanism 306) to a first position, otherwise known herein as a locking position. As the cleat 500 meshes with the mounting mechanism 202, the latching mechanism 300 translates to a second position, also known as a releasing position, which allows the cleat 500 to mesh against the mounting mechanism 202. Once the cleat 500 is fully inserted, the latching mechanism 300 translates back to the locking position. To release the mobile computer 400 from the mount 102, the user can press a button 218 in the direction of arrow 900, which translates the latching mechanism 300 from the locking position back to the releasing position. The latching mechanism 300 includes a first and second latch element 302/304, respectively, which are configured to mesh with a respective recesses 1202/1204 of the cleat 500. In the embodiment depicted in FIG. 12, the latching mechanism 300 is configured to translate independently from the cleat 500, and when the latching mechanism 300 translates in the direction of arrow 900, the latch elements 302/304 disengaged with the recesses 1202/1204 respectively. The mount 102 can then be secured to the arm of a user for use in a commercial environment.

Returning to FIG. 2, the mount 102 further includes options for securing the mount 102 to the user. Anchoring elements 222a/222b/222c/222d (collectively anchoring points 222) are configured to attach to the securing apparatus 104 (not included in FIG. 2). When the securing apparatus 104 is configured to be attached to a plurality of the anchoring elements 222 while wrapping around the underside of the user's arm. Some embodiments may instead use slots 224a/224b (and unseen matching slots on the back side of the mount 102) to secure the mount 102 to the user's arm. In said embodiments, straps may pass through the slots 224 and around the underside of the user's arm to secure the mount 102 to the user's arm. The strap may be secured by hook and loop elements, ratcheting systems, tightening elements, or other methods known in the art for securing strap ends.

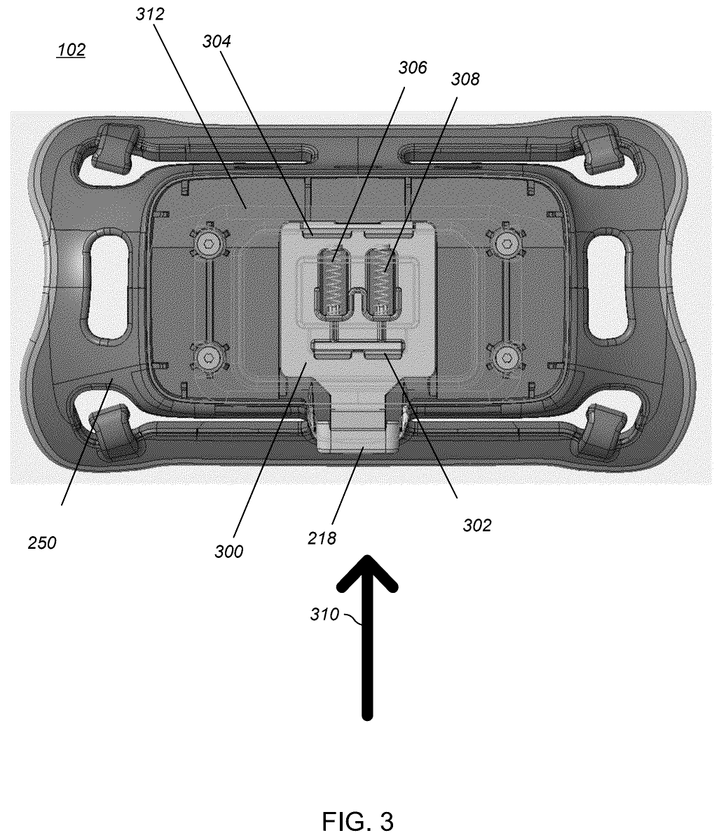

As depicted in FIG. 3, the housing 216 is removed from the embodiment shown in FIG. 2. The mount 102 further includes the mount base 250 and the latching mechanism 300, which is positioned underneath the housing 216 within a compartment 312. The latching mechanism 300 includes the button 218, a first latching element 302, a second latching element 304, and biasing elements 306/308 (depicted in FIG. 3 as springs). While FIG. 3 depicts the latching mechanism including two biasing elements, in other embodiments the biasing element may only include one biasing element. Further, in other embodiments, only one latching element may be present. The first and second latching elements 302/304 are configured to align with a first recess and second recess, respectively of the mounting mechanism 202. As depicted the first latching element 302, and the second latching element 304 extend the width of the mounting mechanism 202. However, it is appreciated that the first and second latching elements 302/304 do not need to extend fully across the mounting mechanism 202.

As we described in further detail below, when the button 218 is pushed in the direction indicated by arrow 310, the latching mechanism 300 moves against a force applied by the biasing elements 306/308. This movement moves the first and second latching elements 302/304 away from the respective recesses which allows the mobile computer to be released.fo to release the mobile computer from the mounts, a user can push the release button, and as pushing the release button lift up on the close the proximal edge of the mobile computer, such that the mobile computer pivots out a connection with the mount 102 and can be removed from the mount 102. The latching mechanism 300, during install or locking of the mobile computer will be translated between a release position and a locking position. The locking position is shown in FIG. 3 when the first and second latching elements are meshed with the mobile computer to secure the mobile computer against the mount 102. When the button 218 is pressed in the direction indicated by arrow 310, the latching mechanism moves in the direction indicated by arrow 310 as well into the release possession. The release position allows the latching elements 302/304 to release the mobile computer so it can be released.

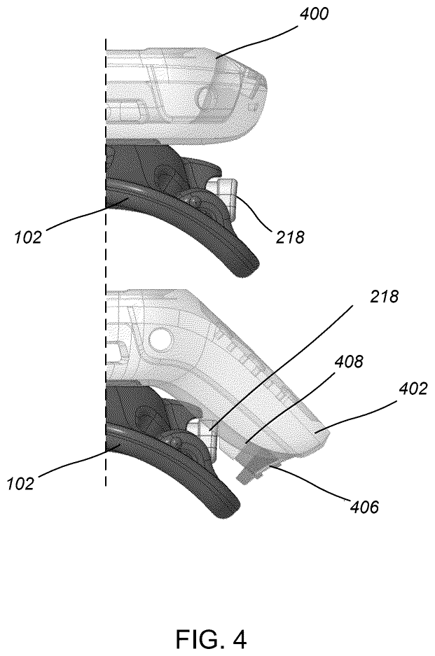

As depicted in FIG. 4, the mobile computer 100 may have multiple embodiments. In one embodiment of the mobile computer 400, the button 218 is accessible when the mobile computer 400 is installed onto the mount 102. In this configuration, the button 218 is accessible and can be pressed to release the mobile computer 400 from the mount 102. In comparison, mobile computer 402 is a different embodiment of mobile computer than mobile computer 400. As depicted in FIG. 4, mobile computer 402 includes an extended keyboard that covers and prevents accessibility to button 218. In this configuration, it is desirable to have a solution that allows access to the button 218 while still having an extended mobile computer 402. As depicted in FIG. 4, in some embodiments, an additional button 406 has been included to the mobile computer 402. The additional button 406 includes the extension element 408 that allows the user to access the button 218 of the mount 102. The additional button 406 is rigidly connected to the extension element 408 in a way such that a translation of additional button 406 depresses button 218 which allows the user to remove the mobile computer 402 from the mount 102.

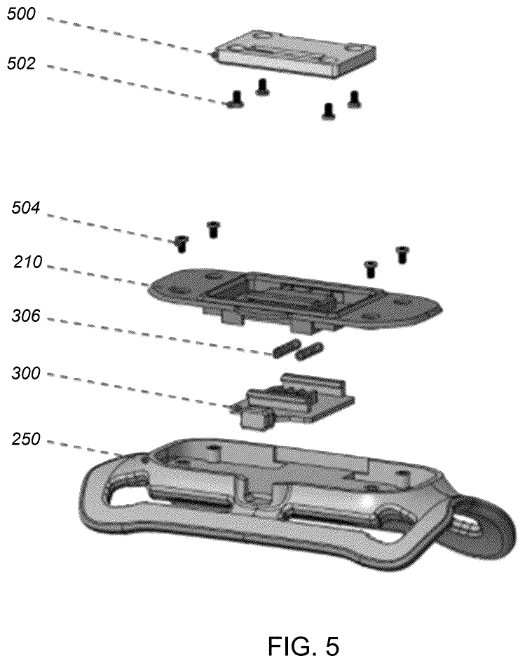

FIG. 5 depicts an exploded view of the cleat 500 and the mount 102. As can be seen in FIG. 5, the cleats 500 is configured to be secured to the mobile computer via fasteners 502. FIG. 5 further depicts fasteners 504 configured to secure the housing 216 to the mounts 102. The housing 210 secures the latching assembly 300 and the biasing elements 306. The biasing elements 306 are configured to be biasing between the latching assembly 300 and the housing to 10. The biasing elements 306 provide a force in the lateral direction as defined by an axis of the biasing element 306 that will bias the latching element 300 into a locked position locking position where the button is extended from the mount base 250. When the button 218 is depressed, the latching mechanism 300 will push against the biasing force applied by the biasing elements 306 which allows the latching mechanism 300 to translate within the compartment within the mount base 250 and then when the button 218 is released the biasing elements 306 will push the latching mechanism 300 into a locking position.

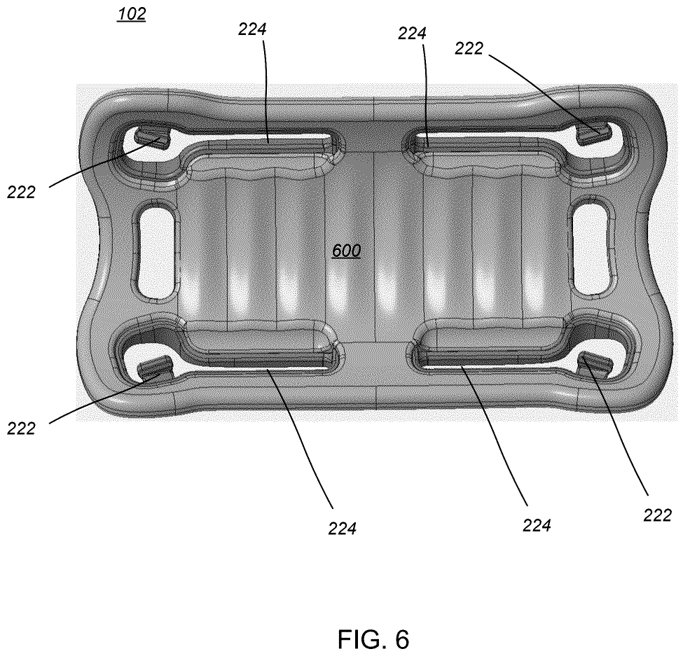

FIG. 6 depicts padding 600, otherwise known as an ergonomic underside, on the second side 206 of the mount 102. In the depicted embodiment, the padding 600 is molded to the underside of the housing of the mount 102. In other embodiments, the padding 600 is hardened plastic. The padding 600 may be ergonomically molded to fit a user's arm comfortably. In some embodiments, the curvature of the padding 600 is contoured to fit around the radial bone of the user's arm. The contour positions a display of a mounted mobile computer more accessible when the user's arm is in a natural position.

FIG. 6 further depicts options for securing the mount 102 to a user's arm. As mentioned above, the mount 102 may be secured via various methods which may be chosen based upon availability, price, or user base. Slots 224 are positioned around the perimeter of the mount 102. A user may feed a strap through pairs of corresponding slots positioned on opposite sides of the mount 102. The strap can be secured around the arm and tightened as needed. The current embodiment of FIG. 6 depicts two sets of opposite slots, each are configurable to receive a strap to secure the mount 102 to the arm of the user. Another option for securement includes the anchoring elements 222. The anchoring elements allow for attachment of looped ends of retaining straps. The looped ends of the retraining straps can be hooked around the anchoring elements 222 which, when secured to each anchoring element 222, will evenly pull from each corner, which provides comfort for the user. The retraining straps may be static, non-stretching fabric straps, elastic straps, or a ratcheting strapping system that will pull from each corner.

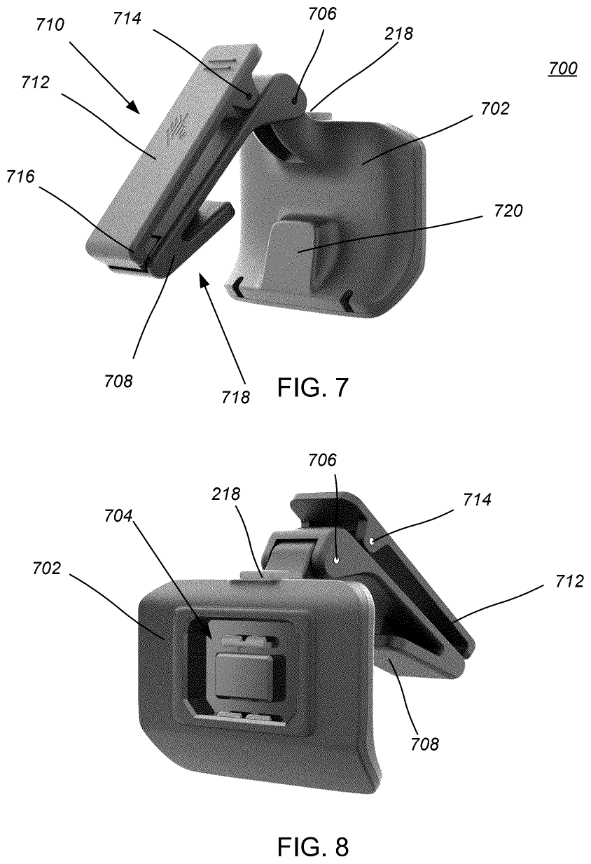

FIGS. 7 and 8 depict an alternative embodiment for the mount 102 for a mobile computer. The mount 700 depicted in FIG. 7 is configured to be worn on the belt of a user such that the mobile computer is located near the user's hip. The hit mount 700 includes a main body 702 which is configured with a mounting mechanism 704. The main body 702 and the clip element 710 are rotatably connected by a first hinge 706. The clip element 710 comprises a first arm 708 and a second arm 712. The first arm 708 is secured to the second arm 712 by second hinge 714. In some embodiments, the second hinge 714 is biased to a closed position where a hook 716, the hook located on the distal end of the second arm 712, is in contact with the first arm 708. The second arm 708 can be pivoted such that the hook 716 moves to an open position where the hook 716 can be slid around the belt of a user and the hook 716 will return to the closed position to secure the belt between the first arm 708 and the second arm 712.

Further depicted in the embodiment of FIG. 7, the first arm 708 of the hip mount 700 includes a first magnetic element 718 positioned to attract a second magnetic element 720 the main body 702 of the hip mount 700. This allows the main body 702 of the hit mount 700 to stay against the hip/leg of the user via the attraction between the magnetic elements. A mobile computer can fit onto the hip mount 700 as described above with regard to the arm mount.

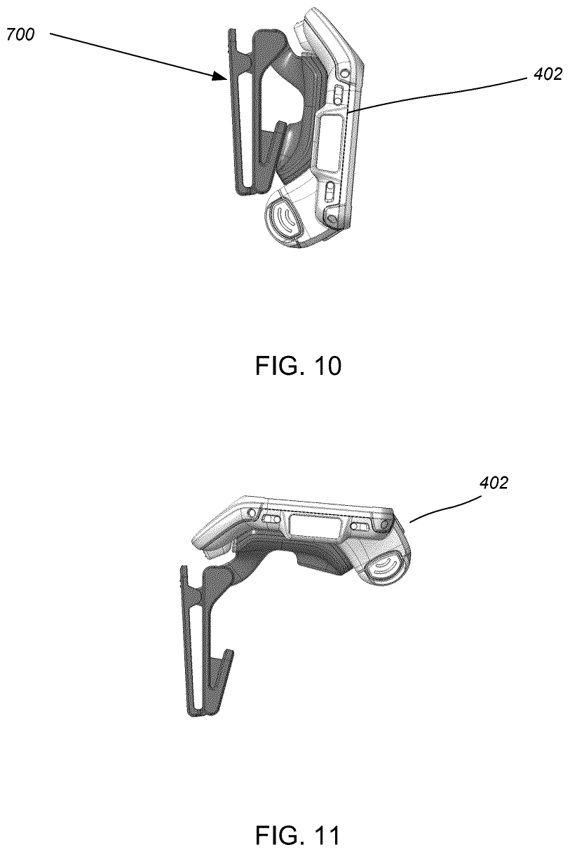

As depicted in FIGS. 10 and 11, the mobile computer 402 is secured to the hip mount 700 (also referred to as a belt mount) and is depicted in two different positions. FIG. 10 depicts the mobile computer 402 in a first position, the first position being substantially vertical. When the mobile computer is in the first position and the belt mount 700 is connected to a belt, the mobile computer 402 lays substantially parallel to a user's leg, which allows the mobile computer 402 to have a low profile and remain unobtrusive to the user's actions. As is depicted in FIG. 11, when the user needs to view a display of the mobile computer 402, the user can pivot the mobile computer 402 and the main body 702 away from the first arm 708 to a substantially horizontal position while the first arm 708 remains secured to the user's belt. As the mobile computer 402 rotates, the user can view the display of the mobile computer as needed and then rotate the mobile computer back to the second position where the first and second magnetic elements 718/720 secure the main body 702 against the first arm 708. In some embodiments, the user can release the mobile computer 402 and the mobile computer can fall due to gravity from the first position to the second position.

As seen in FIG. 8, the mounting mechanism 202 and installation hour as such. In inserting, the far side of the mobile computing terminal would be entered into the mounting mechanism, and then pivoted downward towards the release button of the mount. As the mobile terminal is pivoted downward towards the release button, the latch elements within the mounting mechanism secure onto recesses within the mobile computing terminal.

FIG. 9 depicts two processes for installation of the mobile computer 400 to the mount 102 and the removal from the mobile computer 400 from the mount 102. To remove the mobile computer 400 from the mount 102, the user may use their thumb to depress the button per the arrow 900, and with the button depressed, can lift up the mobile computer 400 in the direction of arrows 902. This allows the mobile computer 400 to pivot away from the mount 102 for removal. With regards to installation of the mobile computer to the mount 102, the mobile computer 400 can be pressed into position per arrow 904. The user can apply pressure downward onto the mount 102 and the mounting mechanism (not seen in FIG. 9) and the downward force will apply a force against the latch elements of the latching mechanism, which causes the latching mechanism to slide which allows the mobile computer to be installed, and then the latching mechanism to slide back into place, securing the mobile computer 400 to the mount 102. It is important to note that while the mount 102 is secured to the arm, and more directly the forearm, of a user, the installation and removal of the mobile computer 400 to the mount 102 be done using one hand. In other words, a user can push the button to release the mobile computer and lift the mobile computer away from the mount with one hand. This allows for the mobile computer to be easily used, swapped, and installed by just the user without needing additional assistance.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, subject matter lies in less than all features of a single disclosed embodiment. Thus, the following claims are hereby incorporated into the Detailed Description, with each claim standing on its own as a separately claimed subject matter.

That which is claimed:

1. A mounting system for a mobile computer, the mounting system comprising:
a mount base;
a housing secured to the mount base forming a compartment between the housing and the mount base; and
a latching mechanism located within the compartment, the latching mechanism comprising a button and at least one latch element, the latching mechanism biased to a first position;
wherein the housing includes at least one opening in which the at least one latch element is configured to secure to the mobile computer.

2. The mounting system of claim 1, wherein, when the latching mechanism is in the first position, the latching mechanism is configured to secure the mobile computer to the mount.

3. The mounting system of claim 1, wherein actuation of the button is operable to move the latching mechanism from the first position to a second position.

4. The mounting system of claim 3, wherein the second position releases the mobile computer from the mount.

5. The mounting system of claim 1, wherein the at least one latching element is configured to engage with a corresponding recess on the mobile computer.

6. The mounting system of claim 1, wherein the mobile computer further comprises an additional button configured to actuate the button when pressed.

7. The mounting system of claim 1, wherein the mount is secured to an arm.

8. The mounting system of claim 1, wherein the mount is configured to be secured to a belt.

9. The mounting system of claim 1, wherein the mount is pivotable from a secured position to a viewing position wherein the mobile computer is in a vertical position when in the secured position and in a horizontal position in the viewing position.

10. The mounting system of claim 1, wherein the mount further includes:
a main body supporting the mounting mechanism, and
a clip element wherein the clip element is rotatably secured to the main body via a first hinge.

11. The mounting system of claim 10, wherein the clip element is configured to secure to a belt.

12. The mounting system of claim 10, wherein the clip element includes a first arm and a second arm wherein the first arm is secured to the second arm via a second hinge.

13. The mounting system of claim 10, wherein the clip element includes a first magnetic element, the first magnetic element configured to magnetically secure to a second magnetic element located on the main body, the second magnetic element opposite the main body from the mounting mechanism.

14. The mounting system of claim 13, wherein the mobile computing can secure to the main body via the mounting mechanism and the mobile computer can be pivoted up by forcing apart the first and second magnet, and when the mobile computer is pivoted down, the first and second magnet reattach.

15. The mounting system of claim 1, wherein the button is pressed and the mobile computer removed from the mounting system with one hand.

16. A mobile computer mounting system comprising:
a mobile computer having a cleat located on a surface of the mobile computer;
a mount including:
a mount base;
a housing secured to the mount base forming a compartment between the housing and the mount base; and
a latching mechanism located within the compartment, the latching mechanism configured to mesh to the cleat to secure the mobile computer to the mount.

17. The mobile computer mounting system of claim 16, wherein:
the latching mechanism includes at least one latch element, and
the cleat includes at least one recess,
wherein the at least one latch element is configured to mesh with the at least one recess through at least one opening in the housing.

18. The mobile computer mounting system of claim 16, wherein the latching mechanism includes a button configured to translate the latching mechanism within the compartment.

19. The mobile computing mounting system of claim 18, wherein an additional button is located on the mobile computer, the additional button is configured to engage the button and translate the latching mechanism.

20. The mobile computing mounting system of claim 16, wherein the mount is configured to be secured to an arm of a user.

21. The mobile computing mounting system of claim 16, wherein the mount is configured to be secured to a belt of a user.

22. The mobile computing mounting system of claim 16, wherein the mount is configured to be pivotably secured such that in a first position, the mobile computer is supported in a substantially vertical position and in a second position, the mobile computer is supported in a substantially horizontal position.
